(19) United States
(12) Patent Application Publication
(10) Pub. No.: US 2012/0201349 A1
(43) Pub. Date: Aug. 9, 2012

(54) GRID FOR USE IN RADIATION IMAGING AND GRID PRODUCING METHOD, AND RADIATION IMAGING SYSTEM

(75) Inventors: Yasuhisa KANEKO, Ashigarakami-gun (JP); Atsushi HASHIMOTO, Ashigarakami-gun (JP)

(73) Assignee: FUJIFILM CORPORATION, Tokyo (JP)

(21) Appl. No.: 13/359,931

(22) Filed: Jan. 27, 2012

(30) Foreign Application Priority Data
Feb. 4, 2011 (JP) 2011-022783

(51) Int. Cl. G21K 1/06; B05D 5/06; G01N 23/04

(52) U.S. Cl. 378/62; 378/145; 427/160

(57) ABSTRACT

An X-ray transmissive substrate is etched to form a plurality of grooves, a plurality of X-ray transmitting sections, and a plurality of supporting portions. The grooves, formed between the X-ray transmitting sections, extend in Y direction and are arranged in X direction orthogonal to the Y direction. In the grooves, the supporting portions protrude from sides of the X-ray transmitting sections in the X direction and are arranged alternately in the Y direction. The supporting portions support the X-ray transmitting sections when the grooves are filled with an X-ray absorbing material through electroplating. The supporting portions prevent the X-ray transmitting sections from falling over due to waves of a plating liquid and uneven growth of the X-ray absorbing material.

### BACKGROUND OF THE INVENTION

1. Field of the Invention

The present invention relates to a grid for use in radiation imaging and a grid producing method, and a radiation imaging system using a grid.

2. Description Related to the Prior Art

When incident on an object, radiation (for example, X-rays) changes its intensity and phase due to interaction with the object. The phase of X-rays interacts with the object more strongly than the intensity of the X-rays does. X-ray phase imaging takes advantage of this property. Using the X-ray phase imaging technique, a high contrast image (hereinafter referred to as the phase contrast image) of a subject with low X-ray absorption is captured based on the phase change (angular change) of the X-rays caused by the subject. Researches on the X-ray phase imaging have been conducted actively.

An X-ray imaging system using the Talbot effect caused by two transmission-type diffraction gratings (grids) to perform the X-ray phase imaging is devised as an example of a radiation imaging system (for example, see Japanese Patent Laid-Open Publication No. 2006-259264 and “Differential X-ray phase contrast imaging using a shearing interferometer”, C. David et al., Applied Physics Letters, Vol. 81, No. 17, October 2002, page 3287). In this X-ray imaging system, a first grid is disposed behind a subject when viewed from an X-ray source. A second grid is disposed downstream from the first grid by the Talbot length. Behind the second grid, an X-ray image detector (a flat panel detector, abbreviated as FPD) is disposed. The FPD detects the X-rays to generate an image. Each of the first and second grids is a stripe-like one-dimensional grid having X-ray absorbing sections and X-ray transmitting sections extending in one direction and arranged alternately in a direction orthogonal to the extending direction. The Talbot length is a distance at which the X-rays passed through the first grid form a self image (fringe image) due to the Talbot effect.

In the X-ray imaging system, a fringe image is generated by superposition (intensity modulation) of the self image of the first grid onto the second grid. The fringe image is detected using a fringe scanning method. Phase information of the subject is obtained from changes in the fringe image caused by the subject. In the fringe scanning method, images are captured every time the second grid is translationally moved in a direction substantially parallel to the plane of the first grid and substantially vertical to a grid direction of the first grid at a scanning pitch that is one of the equal parts of a grid pitch. Angular distribution (differential image of the phase shift) of the X-rays refracted by the object is determined by a change in each pixel value obtained with the X-ray image detector. Based on the angular distribution, the phase contrast image of the object is obtained. The fringe scanning method is also used in an imaging apparatus using laser light (for example, see “Improved phase-shifting method for automatic processing of moiré deflectograms”, Hector Canabal, et al., Applied Optics, Vol. 37, No. 26, Sep. 1998, page 6227).

Each of the first and second grids has a stripe-like structure in which the X-ray absorbing sections are arranged at a predetermined pitch in an arranging direction. The X-ray absorbing sections extend in the extending direction orthogonal to an X-ray irradiation direction. The arranging direction is orthogonal to the X-ray irradiation direction and the extending direction. The width of each X-ray absorbing section and an arrangement pitch of the X-ray absorbing sections are determined based on a distance between an X-ray focal point and the first grid and a distance between the first and second grids. The width and the arrangement pitch is the order of from several to tens μm. Because the X-ray absorbing sections of the second grid require high X-ray absorption property, each of the X-ray absorbing sections needs a structure with a high aspect ratio. For example, the thickness of the X-ray absorbing section in the X-ray traveling direction needs to be of the order of from tens to hundreds μm.

To produce the above-described grid, in the Japanese Patent Laid-Open Publication No. 2006-259264, as shown in FIG. 16A, a plurality of grooves 102 are formed using photolithography on a photosensitive resin layer 101 provided on a substrate 100. Thereby, a grid pattern in which a plurality of plate-like sections 103 stand vertically on the substrate 100 is formed. The plate-like sections 103 are made of photosensitive resin. The grooves 102 are filled with Au through electroplating to form X-ray absorbing sections.

“Soft X-ray lithography of high aspect ratio SU8 submicron structures” by E. Reznikova et al., in Microsyst. Technol., 14 (2008) 1683-1688 discloses that beams for connecting adjacent grating webs are provided randomly in an extending direction of a grating gap to stabilize a grid structure in which the grating webs and the grating gaps are arranged alternately and periodically. The grating webs correspond to the X-ray absorbing sections. The grating gaps correspond to the X-ray transmitting sections. On the other hand, the U.S. Patent Application Publication No. 2010/0278297 discloses to set the intervals between the beams in the extending direction of the grating gaps so as to satisfy predetermined geometric conditions. This prevents bending of the grating webs caused by capillary force acting in the grating gaps of the “Soft X-ray lithography of high aspect ratio SU8 submicron structures”.

In the grid producing method disclosed in the Japanese Patent Laid-Open Publication No. 2006-259264, a grid pattern composed of the grooves 102 and the plate-like sections 103 is formed by exposure and development on the photosensitive resin layer 101. Because the photosensitive resin is soft and the grid pattern is minute and has a high aspect ratio, distortion of the grid pattern due to sticking of the adjacent plate-like sections 103 is likely to occur. The sticking is caused by waves (swinging) of a solution during development and/or surface tension of water during drying. As shown in FIG. 16B, the plate-like sections 103 topple or fall over to the adjacent plate-like sections 103, which makes it difficult to maintain the width and height of the grid. Additionally, Au is more rigid than the resin, so distortion of the plate-like sections 103 is likely to occur depending on the growth of the Au plating. This deteriorates grid performance.

In the grid producing method disclosed in the Japanese Patent Laid-Open Publication 2006-259264, synchrotron radiation is used for the exposure of the photosensitive resin layer.

However, in Japan, there are few facilities capable of providing synchrotron radiation exposure. The synchrotron radiation exposure needs along time, which is not suitable for manufacture due to poor throughput. To solve the problem, the silicon substrate that is more rigid than the photosensitive resin layer may be used instead of the photosensitive resin layer. However, it is still difficult to prevent the sticking, because the grid pattern is minute and has a high aspect ratio.

In the invention disclosed in the U.S. Patent Application Publication No. 2010/0278297 and the “Soft X-ray lithography of high aspect ratio SU8 submicron structures”, the beams connect the grating webs (corresponding to the X-ray absorbing sections), which strengthens the structure of the grating webs. However, the beams disclosed are not effective for preventing the sticking of the photosensitive resin layers in forming the grating webs using a method disclosed in the Japanese Patent Laid-Open Publication No. 2006-259264, for example.

### SUMMARY OF THE INVENTION

An object of the present invention is to provide a grid having X-ray absorbing sections with high aspect ratio and a method for producing a grid with high precision, and a radiation imaging system using a grid.

To achieve the above and other objects, a grid for use in radiation imaging includes a plurality of radiation absorbing sections, a plurality of radiation transmitting sections, a plurality of radiation transmitting sections, and a plurality of supporting portions. The radiation absorbing sections extend in an extending direction. The radiation transmitting sections extend in the extending direction. The radiation absorbing sections and the radiation transmitting sections are arranged alternately in an arranging direction orthogonal to the extending direction. The supporting portions protrude in the arranging direction from at least one of sides of the radiation transmitting sections.

It is preferable that the supporting portions do not contact the adjacent radiation transmitting section.

It is preferable that the supporting portions are provided on both sides of the radiation transmitting section alternately in the extending direction.

It is preferable that the supporting portions are protruded in the opposite directions from the both sides of a same position of the radiation transmitting section.

It is preferable that the supporting portions protruding from the adjacent radiation transmitting sections in the arranging direction face each other.

It is preferable that the supporting portion includes a bent portion in which the radiation transmitting section is bent stepwise.

It is preferable that an arrangement pitch of the supporting portions in the extending direction is greater than or equal to 5 times a width of the radiation absorbing section in the arranging direction.

It is preferable that the arrangement pitch of the supporting portions in the extending direction is less than or equal to a pixel size of a radiation image detector for detecting radiation passed through the radiation transmitting sections.

It is preferable that the grid further includes an absorbing section supporting portion protruded from at least one of sides of the radiation absorbing section.

A radiation imaging system includes a first grid, an intensity modulator, a radiation image detector, and a processing section. The first grid has a plurality of radiation absorbing sections and a plurality of radiation transmitting sections. The radiation absorbing sections and radiation transmitting sections extend in an extending direction and are arranged alternately in an arranging direction orthogonal to the extending direction. The first grid passes radiation emitted from a radiation source to form a first periodic pattern image. The first grid has a plurality of supporting portions protruding in the arranging direction from at least one of sides of the radiation transmitting sections. The intensity modulator provides intensity modulation to the first periodic pattern image in at least one of relative positions out of phase with the first periodic pattern. The radiation image detector detects a second periodic pattern image generated in the relative position by the intensity modulator. The processing section generates an image of phase information based on at least one of the second periodic pattern images detected by the radiation image detector.

It is preferable that the intensity modulator is composed of a second grid and a scanning section. The second grid has a plurality of radiation transmitting sections, a plurality of radiation absorbing sections, and a plurality of supporting portions. The radiation transmitting sections and the radiation absorbing sections extend in an extending direction and are arranged alternately in an arranging direction orthogonal to the extending direction. The radiation transmitting sections pass the first periodic pattern. The radiation absorbing sections absorb the first periodic pattern. The supporting portions protrude in the arranging direction from at least one of sides of the radiation transmitting sections. The scanning section moves one of the first and second grids to positions at a pitch in a periodic direction of grid structures of the first and second grids. The positions correspond to the relative positions.

It is preferable that the radiation imaging system further includes a third grid composed of a plurality of radiation absorbing sections, a plurality of radiation transmitting sections, and a plurality of supporting portions. The radiation absorbing sections and radiation transmitting sections extend in the extending direction and are arranged alternately in the arranging direction orthogonal to the extending direction. The supporting portions protrudes in the arranging direction from at least one of sides of the radiation transmitting sections. The third grid is placed between the radiation source and the first grid. The third grid partly shields the radiation from the radiation source to form a plurality of linear light sources.

A grid producing method includes a first forming step and a second forming step. In a first forming step, a plurality of grooves, a plurality of radiation transmitting sections, and a plurality of supporting portions are formed on a radiation transmissive substrate. The grooves extend in an extending direction and are arranged in an arranging direction orthogonal to the extending direction. The grooves are formed between the radiation transmitting sections. The supporting portions protrudes in the arranging direction from at least one of sides of the radiation transmitting sections. In the second forming step, a plurality of radiation absorbing sections are formed by filling the grooves with a radiation absorbing material.

It is preferable that the supporting portions do not contact the adjacent radiation transmitting section.

According to the grid of the present invention for use in radiation imaging, the supporting portions support the radiation transmitting sections to strengthen the grid. This prevents or reduces a change in pitch and the like between the X-ray absorbing sections and that between the X-ray transmitting sections caused by distortion of the grid. Thus, a radiation imaging system using the grid of the present invention allows phase contrast imaging with high image quality.

According to the grid producing method of the present invention, the supporting portions support each of the radiation transmitting sections. This prevents the radiation transmitting sections from toppling or falling over when a radiation absorbing material is filled in the grooves between the radiation transmitting sections to form the radiation absorbing sections. Because the supporting portions do not contact the adjacent X-ray transmitting section, the supporting portions do not block the flow of the plating liquid in the groove when the groove is filled with the X-ray absorbing material through electroplating.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic view showing a configuration of an X-ray imaging system of the present invention; p FIG. 2A is a plan view showing a configuration of a second grid;

FIG. 2B is a cross sectional view cut along a line A-A shown in FIG. 2A;

FIGS. 3A to 3D are cross-sectional views showing steps for producing the second grid;

FIG. 4 is a perspective view showing an X-ray transmissive substrate on which X-ray transmitting sections and supporting portions are formed;

FIG. 5 is a cross-sectional view showing a supporting portion with a different amount of protrusion in a height direction of the X-ray transmitting section;

FIG. 6 is a cross-sectional view of a supporting portion protruded from the middle of the X-ray transmitting section in the height direction;

FIG. 7 is a plan view of a second grid in which the supporting portions are arranged diagonally;

FIG. 8 is a plan view of a second grid in which spaces between the supporting portions of the adjacent X-ray transmitting sections are random;

FIG. 9 is a plan view of a second grid in which the supporting portions are protruded in the opposite directions from the both sides of the same position of the X-ray transmitting section;

FIG. 10 is a plan view of a second grid in which the supporting portions of the adjacent X-ray transmitting sections are protruded to face each other;

FIG. 11 is a cross-sectional view of a second grid from which the X-ray transmitting sections are removed;

FIG. 12 is a plan view of a second grid provided with absorbing section supporting portions and transmitting section supporting portions;

FIG. 13 is a plan view of a second grid in which each of absorbing section supporting portions, having the same shape as transmitting section supporting portion, is provided in the position corresponding to and in the same direction as the transmitting section supporting portion;

FIG. 14 is a plan view of a second grid with transmitting section supporting portions of different shapes and absorbing section supporting portions of corresponding shapes are provided in the positions corresponding to the respective transmitting section supporting portions;

FIG. 15 is a plan view of a second grid with bent X-ray absorbing sections and bent X-ray transmitting sections; and

FIGS. 16A and 16B are perspective views showing plate-like sections falling over to the adjacent sections.

### DESCRIPTION OF THE PREFERRED EMBODIMENTS

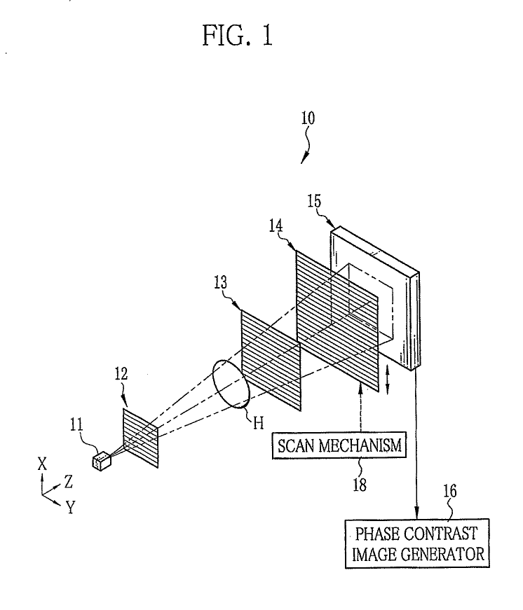

In FIG. 1, a radiation imaging system, for example, an X-ray imaging system 10 is provided with an X-ray source 11, a source grid 12, a first grid 13, a second grid 14, and an X-ray image detector 15 disposed in Z direction that is the X-ray irradiation direction. The X-ray source 11 has, for example, a rotating anode type X-ray tube and a collimator for restricting an X-ray field. The X-ray source 11 applies cone-beam shaped X-rays to a subject H. The X-ray image detector 15 is, for example, a flat panel detector (FPD) using a semiconductor circuit. The X-ray image detector 15 is disposed behind the second grid 14 . The X-ray image detector 15 is connected to a phase contrast image generator 16 that generates a phase contrast image from image data detected by the X-ray image detector 15.

Each of the source grid 12, the first grid 13, and the second grid 14 is an absorption grid for absorbing the X-rays. The source grid 12, the first grid 13, and the second grid 14 are disposed in the Z direction to face the X-ray source 11. There is a space between the source grid 12 and the first grid 13 enough to place the subject H. A distance between the first grid 13 and the second grid 14 is less than or equal to a minimum Talbot length. The X-ray imaging system 10 of this embodiment does not use Talbot effect. Instead, the X-ray imaging system 10 uses the first grid 13 to project the X-rays to the second grid 14.

The second grid 14 and a scan mechanism 18 constitute an intensity modulator of the present invention. In the phase contrast imaging, the scan mechanism 18 moves the second grid 14 translationally in a grid pitch direction (X direction) at a scanning pitch that is one of equal parts (for example, five parts) of a grid pitch of the second grid 14.

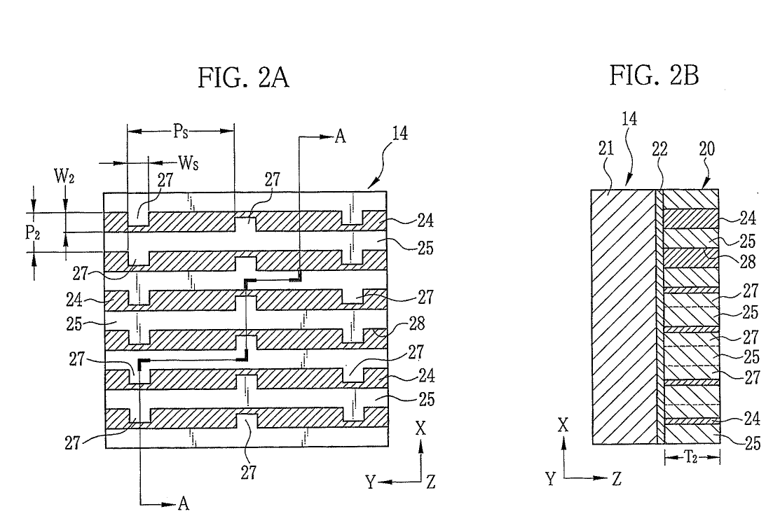

A structure of the second grid 14a is described as an example of a grid of the present invention. In FIGS. 2A and 2B, the second grid 14 has a grid layer 20 that functions as a grid, a substrate 21 provided to the grid layer 20 on an X-ray source 11 side, and a seed layer 22 provided between the grid layer 20 and the substrate 21.

The grid layer 20 is provided with a plurality of X-ray absorbing sections 24 and a plurality of X-ray transmitting sections 25. The X-ray absorbing sections 24 and the X-ray transmitting sections 25 extend in an extending direction (Y direction) in a plane orthogonal to the Z direction. The X-ray absorbing sections 24 and the X-ray transmitting sections 25 are arranged alternately in an arranging direction (X direction) orthogonal to the Y and Z directions to form a stripe-like grid. The X-ray transmitting sections 25 are made from a material which has X-ray absorption property lower than the X-ray absorbing sections 24. The X-ray absorbing sections 24 absorb or shield the X-rays emitted from the X-ray source 11, while the X-ray transmitting sections 25 allow the X-rays to pass therethrough. Thereby, a stripe-like image is formed.

The substrate 21 is made from a material with low X-ray absorption property, similar to the X-ray transmitting sections 25, and rigidity to support the grid layer 20. The seed layer 22 is made from a material with conductivity. The seed layer is used as an electrode when the X-ray absorbing sections 24 are produced through electroplating. The seed layer 22 is thinner than the grid layer 20 and the substrate 21, so it does not affect the X-ray transmission property of the second grid 14.

A width W2 and a pitch P2 of the X-ray absorbing section 24 is determined based on a distance between the source grid 12 and the first grid 13, a distance between the first grid 13 and the second grid 14, and an arrangement pitch of the X-ray absorbing sections of the first grid 13, for example. The width W2 is approximately from 2 μm to 20 μm. The pitch P2 is of the order of from 4 μm to 40 μm. The X-ray absorption property of the X-ray absorbing section 24 increases as a thickness T2 of the X-ray absorbing section 24 in the Z direction increases. However, in consideration of vignetting of the cone-beam shaped X-rays applied from the X-ray source 11, the thickness T2 is of the order of from 100 μm to 200 μm, for example. In this embodiment, the width W2 is 2.5 μm, the pitch P2 is 5 μm, and the thickness T2 is 100 μm, by way of example. An aspect ratio of the X-ray absorbing section 24 is “40”.

On a side of each of the X-ray transmitting sections 25, two or more beam-like supporting portions 27 are provided integrally with the X-ray transmitting section 25. Each supporting portion 27 is protruded from the X-ray transmitting section 25 with an amount of protrusion uniform in the height direction (Z direction) from the substrate 21. The supporting portions 27 strengthen the second grid 14 and prevent distortion thereof. During production of the second grid 14, the supporting portions 27 reinforce the X-ray transmitting sections 25 to prevent the X-ray transmitting sections 25 from toppling or falling over.

The supporting portions 27 are provided alternately on both sides of the X-ray transmitting section 25 along the extending direction of the X-ray transmitting section 25. To prevent the supporting portions 27 from protruding from an edge of the second grid 14 toward outside, each of the X-ray transmitting sections 25 located at an edge of the second grid 14 has the supporting portions 27 only on the inside of the X-ray transmitting section 25. The supporting portions 27 of each of the X-ray transmitting sections 25 are disposed on the positions corresponding to the respective supporting portions 27 of the adjacent X-ray transmitting sections 25 in the Y direction. The supporting portions 27 of the X-ray transmitting sections 25 are aligned linearly in the X direction. Note that each of the supporting portions 27 does not contact the adjacent X-ray transmitting section 25 in the X direction. This prevents the supporting portions 27 from blocking the flow of plating liquid in a groove 28 during electroplating in which Au is filled in the groove 28 between the X-ray transmitting sections 25.

A width Ws of the supporting portion 27 in the Y direction is the same as the width W2 of the X-ray absorbing section 24 in the X direction, for example. An arrangement pitch Ps in the Y direction between the supporting portions 27 of the single X-ray transmitting section 25 is greater than or equal to 5 times the width W2. This prevents a decline in grid performance due to too many supporting portions 27. It is preferable that the arrangement pitch Ps of the supporting portions 27 is less than or equal to a length of a pixel size of the X-ray image detector 15 in the Y direction. When the arrangement pitch Ps exceeds the length of the single pixel, some of the pixels face the supporting portions 27 while others do not. This causes a difference between pixels in X-ray transmittance of the grid. The X-ray image detectors 15 differ in pixel size according to use. For common radiography, a pixel size in the X and Y directions is 150 μm-300 μm by 150 μm-300 μm square. For mammography, the pixel size is the order of 50 μm-70 μm by 50 μm-70 μm square. Accordingly, it is preferable that the arrangement pitch Ps of the supporting portion 27 is set according to the X-ray image detector 15.

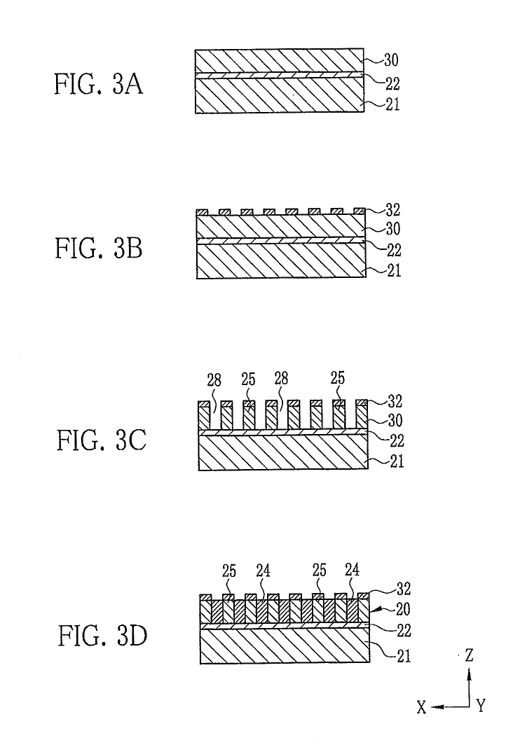

Next, a method for producing the second grid 14 is described. As shown in FIG. 3A, in a first step, an X-ray transmissive substrate 30 and the substrate 21, on one side of which is provided with the seed layer 22, are bonded together through the seed layer 22. The X-ray transmissive substrate 30 constitutes the X-ray transmitting section 25 of the grid layer 20.

It is necessary that the material of the X-ray transmissive substrate 30 has low X-ray absorption property, rigidity, and processability. For example, silicon (Si) is preferable. Alternatively or in addition, GaAs, Ge, quarts, or the like may be used. The thickness of the X-ray transmissive substrate 30 corresponds to the thickness T2 of the X-ray absorbing section 24 in the Z direction. The thickness of the X-ray transmissive substrate 30 is, for example, from 20 μm to 150 μm.

The substrate 21 is made from a material with low X-ray absorption property and a small difference in thermal expansion coefficient compared to the X-ray transmissive substrate 30. For example, borosilicate glass, soda-lime glass, quarts, alumina, GaAs, or Ge is preferable. The silicon the same as that used for the X-ray transmissive substrate 30 is more preferable. For the borosilicate glass, Pyrex (registered trademark) glass or Tempax (registered trademark) glass can be used, for example. As described above, the substrate 21 is made from the material which has a small difference in thermal expansion coefficient compared with the X-ray transmissive substrate 30. This prevents distortion caused by thermal stress during bonding of the substrate 21 and the X-ray transmissive substrate 30, and that during use.

It is preferable that the seed layer 22 is constituted of a metal film made of Au, Ni, Al, Ti, Cr, Cu, Ag, Ta, W, Pb, Pd, Pt, or their alloy, for example. The seed layer 22 may be provided to the X-ray transmissive substrate 30. The seed layer 22 may be provided to each of the X-ray transmissive substrate 30 and the substrate 21. The seed layer 22 has a thickness of the order of several μm, so the seed layer 22 does not affect the X-ray transmission property even if the seed layer 22 is made from a material with high X-ray absorption property, for example, Au.

The total thickness of the substrate 21 including the seed layer 22 is thicker than the thickness of the X-ray transmissive substrate 30. The total thickness of the substrate 21 is, for example, of the order of from 100 μm to 700 μm. The substrate 21 may have the thickness greater than necessary before the bonding. After the bonding, the substrate may be polished to reduce the thickness to the desired one.

As shown in FIG. 3B, an etch mask 32 is formed using a common photolithography technique on the X-ray transmissive substrate 30. The etch mask 32 is composed of a striped pattern extending linearly in the Y direction and arranged periodically at a predetermined pitch in the X-direction, and a pattern for the supporting portions 27 protruded in the X-direction from the striped pattern.

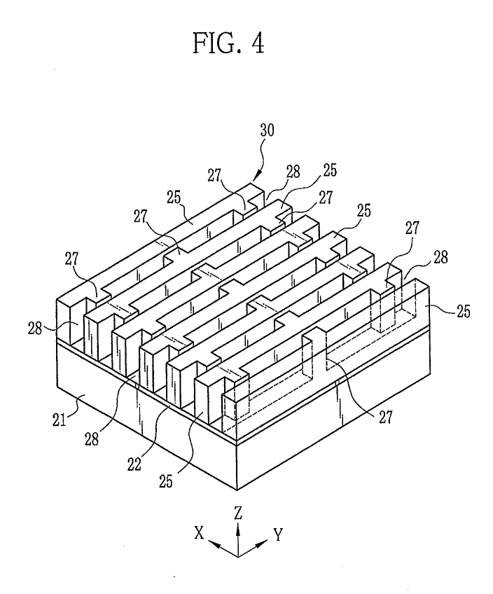

As shown in FIGS. 3C and 4, the X-ray transmissive substrate 30 is subjected to dry etching through the etch mask 32. Thereby, the grooves 28, the plate-like X-ray transmitting sections 25 between which form the groove 28, and a plurality of supporting portions 27 are formed on the X-ray transmissive substrate 30. The groove 28 needs a high aspect ratio between the depth of the order of from 100 μm to 200 μm and the width of the order of several μm, for example. To form the grooves 28, deep dry etching process, for example, Bosch process, or cryo process may be used. A photoresist may be used instead of the silicon substrate. In this case, the grooves are formed using synchrotron radiation exposure.

As shown in FIG. 3D, the X-ray transmissive substrate 30 is subjected to electroplating. In this electroplating step, the X-ray transmissive substrate 30 is immersed in a plating liquid in a state that a current terminal (not shown) is connected to the seed layer 22. Another electrode (anode, not shown) is provided at a position opposite to the current terminal relative to the X-ray transmissive substrate 30. When an electric current is applied between the current terminal and the anode, metal ions in the plating liquid are deposited on the X-ray transmissive substrate 30 which has gone through the pattern processing. Thereby, the grooves 28 are filled with an X-ray absorbing material such as gold to form the X-ray absorbing sections 24. After the electroplating step, the etch mask 32 is removed using a CMP device, for example.

During the electroplating, the X-ray transmitting section 25 is pressed by waves (swinging) of the plating liquid and uneven growth of the metal. Because the X-ray transmitting section 25 is supported by and reinforced with the supporting portions 27, sticking due to toppling or falling over of the X-ray transmitting section 25 is prevented. Because each groove 28 is not divided by the supporting portions 27, fluidity of the plating liquid is maintained in the groove 28. This reduces occurrence of uneven growth of the metal caused by holdup or blockage of the plating liquid and prevents the sticking resulting therefrom. The supporting portions 27 supporting each of the X-ray transmitting sections 25 strengthen the second grid 14.

Similar to filler beams disclosed in U.S. Patent Application Publication No. 2010/0278297 and “Soft X-ray lithography of high aspect ratio SU8 submicron structures” by E. Reznikova et al., in Microsyst. Technol., 14 (2008) 1683-1688, the adjacent X-ray transmitting sections 25 may be connected through the supporting portions 27. However, this divides the groove 28 and blocks the flow of the plating liquid. Accordingly, it is preferable to support each transmitting section 25 by the supporting portions 27 such that the adjacent X-ray transmitting sections 25 are not connected to each other through the supporting portions 27.

Similar to the second grid 14, each of the source grid 12 and the first grid 13 is composed of a grid layer and a substrate (not shown). Similar to the grid layer 20 of the second grid 14, the grid layer of each of the source grid 12 and the first grid 13 is provided with a plurality of X-ray absorbing sections and X-ray transmitting sections both extending in the Y direction and arranged alternately in the X direction. Each of the X-ray transmitting sections is provided integrally with the supporting portions. The source grid 12 and the first grid 13 are similar to the second grid 14 except for the a width of each of the X-ray absorbing sections and the X-ray transmitting sections in the Y direction, a pitch of the X-ray absorbing sections, a pitch of the X-ray transmitting sections, and the thickness of each of the X-ray absorbing sections and the X-ray transmitting sections in the Z direction. Accordingly, descriptions of the source grid 12 and the first grid 13 are omitted. Methods for producing the source grid 12 and the first grid 13 are also similar to that for the second grid 14, so descriptions thereof are omitted.

Next, an operation of the X-ray imaging system 10 is described. The X-rays emitted from the X-ray source 11 is partly shielded by the X-ray absorbing sections of the source grid 12 such that the effective focal size is reduced in the X direction. Thereby, a plurality of linear light sources (extended sources) are formed in the X-direction. A phase difference occurs when the X-rays from the linear light sources pass through the subject H. Then, the X-rays pass through the first grid 13 to form a fringe image (first periodic pattern image). The fringe image carries transmission phase information of the subject H. The transmission phase information is determined by a refractive index of the subject H and a transmission optical path length. The fringe images formed by the respective linear light sources are projected to the second grid 14 and coincide with each other at the position of the second grid 14. This improves image quality of the phase contrast image without reducing the X-ray intensity.

The second grid 14 modulates intensity of the fringe image to form a second periodic pattern image. The second periodic pattern image is detected using a phase scanning method, for example. In the fringe scanning method, the X-ray source 11 emits the X-rays to the subject H and images are captured using the X-ray image detector 15 every time the second grid 14 is translationally moved by the scan mechanism 18 in the X direction relative to the first grid 13 at a scanning pitch that is one of the equal parts (for example, the five equal parts) of a grid pitch. Then, a differential phase image (corresponding to angular distribution of the X-rays refracted by the subject H) is obtained by calculating a phase shift value (a difference in phase at the presence and absence of the subject H) of the pixel data of each pixel in the X-ray image detector 15. The differential phase image is integrated in the X direction using the phase contrast image generator 16. Thereby, a phase contrast image is obtained.

As described above, in each of the source grid 12, the first grid 13, and the second grid 14 of this embodiment, each of the X-ray transmitting sections 25 is provided with the supporting portions 27. As a result, the sticking between the X-ray transmitting sections 25 is prevented and thus the grid with high precision is produced. Thereby, the imaging system 10 using the source grid 12, the first grid 13, and the second grid 14 of this embodiment improves the image quality of the phase contrast image. The supporting portions 27 strengthen the grid, which reduces the distortion and the like of the grid.

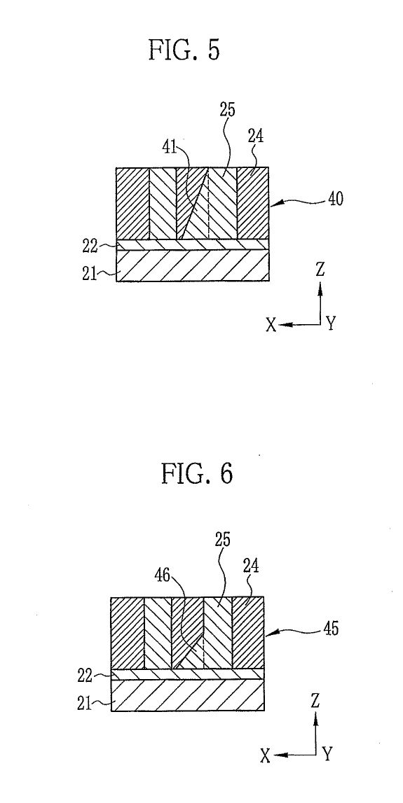

In the above embodiments, the beam-like supporting portion 27 is formed to protrude from the side of the X-ray transmitting section 25. The amount of protrusion of the supporting portion 27 from the side of the X-ray transmitting section 25 is uniform from the top to the bottom of the X-ray transmitting section 25. Alternatively, like a second grid 40 shown in FIG. 5, supporting portions 41 may be formed. An amount of the protrusion of each supporting portion 41 from the side of the X-ray transmitting section 25 gradually increases from the top to the bottom of the X-ray transmitting section 25. When viewed laterally, the supporting portion 41 has a triangular shape. Alternatively, like a grid 45 shown in FIG. 6, supporting portions 46 may be formed. An amount of the protrusion of each supporting portion 46 from the side of the X-ray transmitting section 25 gradually increases from the middle to the bottom of the X-ray transmitting section 25. When viewed laterally, the supporting portion 46 has a triangular shape. The supporting portions 41 and 46 also prevent the sticking between the X-ray transmitting sections 25, similar to the beam-like supporting portions 27. The supporting portions 41 and 46 reduce their influences on the X-ray absorption amount of the grid when compared with the supporting portions 27.

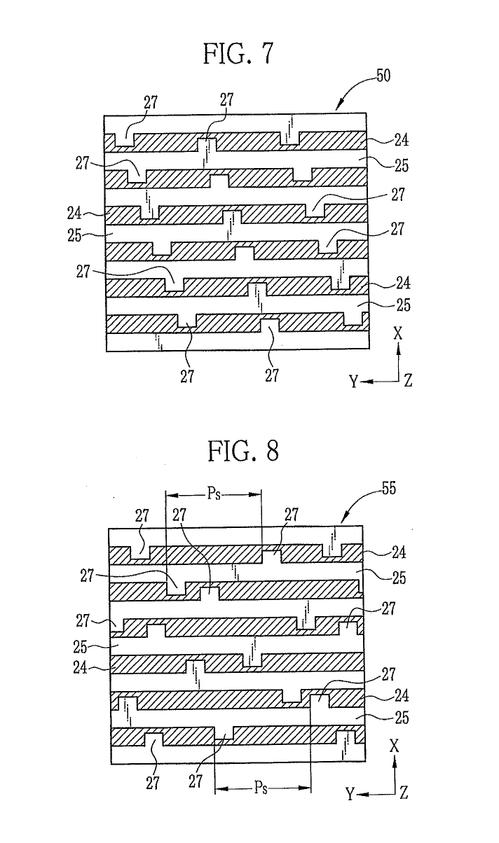

In the above embodiments, the supporting portions 27 of the X-ray transmitting sections 25 are aligned linearly in the X direction. Alternatively, like a second grid 50 shown in FIG. 7, the supporting portions 27 may be aligned in a diagonal direction relative to the X direction.

Alternatively, like a second grid 55 shown in FIG. 8, the

X-ray transmitting sections 25 may be arranged such that the intervals between the supporting portions 27 of the adjacent X-ray transmitting sections 25 are random in the Y direction while the arrangement pitch Ps of the supporting portions 27 provided to the single X-ray transmitting section 25 is kept constant. Alternatively, the arrangement pitch Ps of the supporting portions 27 of each X-ray transmitting section 25 may be set randomly on condition that the arrangement pitch Ps of the supporting portions 27 is greater than or equal to 5 times the width Ws of the supporting portion 27 and less than or equal to the pixel size of the X-ray image detector 15. It is preferable to arrange the supporting portions 27 randomly in view of reducing the decline in the grid performance. Thereby, uneven distribution of the supporting portions 27 that reduce the X-ray shielding property is prevented.

As shown in FIG. 8, the arrangement pitch Ps of the supporting portions 27 may be distributed within a range (a±b/2), centered at a value “a” with a width “b”. For example, when the center value “a” is 30 μm and the width b is 10 μm, the arrangement pitch Ps is within a range from 25 μm to 35 μm. The arrangement pitch Ps may be a prime number. In this case, for example, prime numbers greater than or equal to 25 μm and less than or equal to a pixel size of the X-ray image detector 15 in the X and Y directions (for example, 150 μm square) may be used sequentially or randomly. Alternatively, for example, each of the prime numbers “0, 1, 3, 5, 7, 11, 13, 17, 19” may be added to a starting value 25 μm, being the reference value, of a bridge pitch U. The sums “25, 26, 28, 30, 32 . . . ” may be used sequentially or randomly.

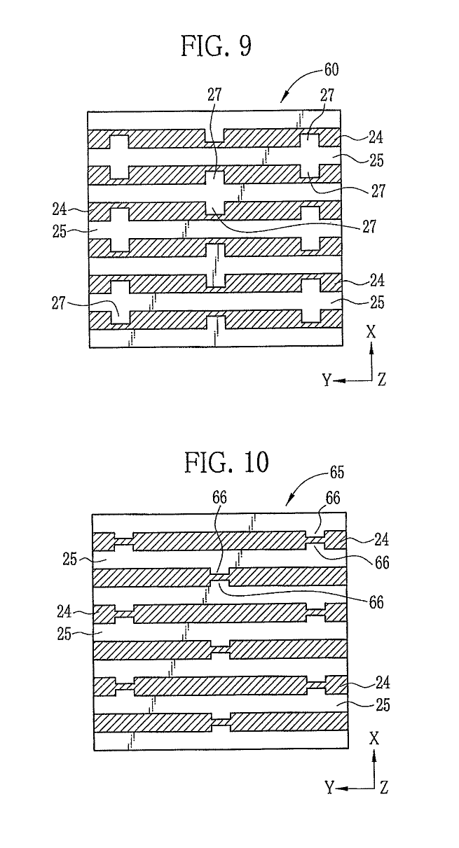

Like a second grid 60 shown in FIG. 9, the supporting portions 27 may be formed to protrude in the opposite directions from the both sides of the same position of the X-ray transmitting section 25. The supporting portions 27 may be arranged in a staggered manner in the X-Y plane. Thereby, the supporting portions 27 support the X-ray transmitting section 25 more firmly. Like a second grid 65 shown in FIG. 10, supporting portions 66 may be formed such that the supporting portions 66 of the adjacent X-ray transmitting sections 25 face each other. The supporting portions 66 may be arranged in a staggered manner. It is preferable that the amount of protrusion of the supporting portion 66 is less than that of the supporting portion 27 in FIG. 9 so as not to come in contact with each other.

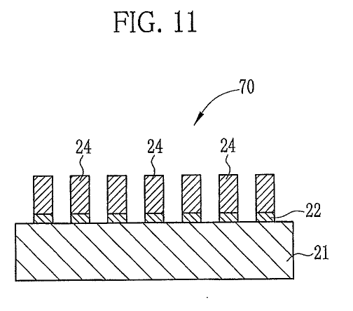

In the above embodiments, the second grid has the X-ray absorbing section 24 made from the X-ray absorbing material and the X-ray transmitting sections 25 made of the X-ray transmissive substrate 30. Alternatively, like a second grid 70 shown in FIG. 11, the X-ray transmitting sections 25 may be removed by etching or the like after the X-ray absorbing sections 24 are formed by filling the grooves 28 with the X-ray absorbing material as shown in FIG. 3D. Thereby, each of the X-ray transmitting sections is a gap between the X-ray absorbing sections 24, which improves the X-ray transmittance.

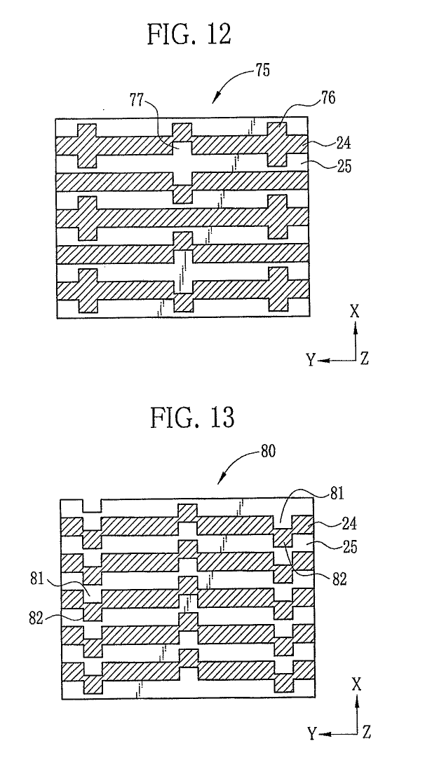

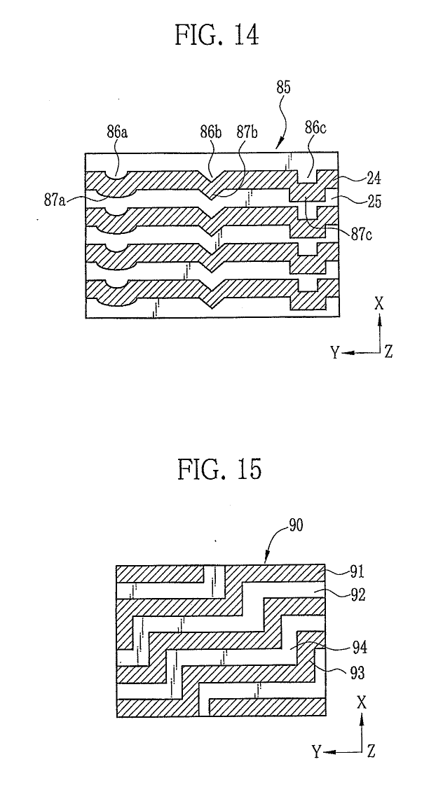

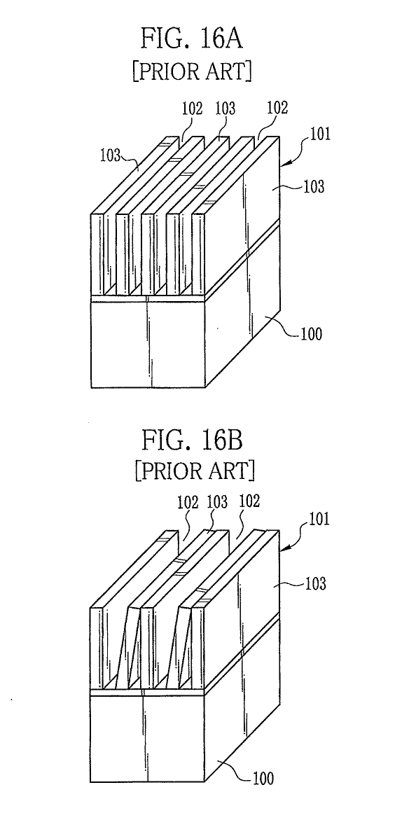

By removing the X-ray transmitting sections 25 from the second grid 70, only the X-ray absorbing sections 24 stand upright on the substrate 21. This makes the X-ray absorbing sections 24 fall over easily. To solve the problem, for example, like a second grid 75 shown in FIG. 12, absorbing section supporting portions 76 may be provided to the X-ray absorbing sections 24 and transmitting section supporting portions 77 may be provided to the X-ray transmitting sections 25. Like a second grid 80 shown in FIG. 13, an absorbing section supporting portion 82, having the same shape as a transmitting section supporting portion 81, may be provided at the position corresponding to the transmitting section supporting portion 81 of the adjacent X-ray transmitting section 25, in the same direction as the transmitting section supporting portion 81. Like a second grid 85 shown in FIG. 14, the X-ray transmitting section 25 may be provided with transmitting section supporting portions 86a, 86b, and 86c, different in shape. On the X-ray absorbing section 24, absorbing section supporting portions 87a, 87b, and 87c may be provided in the positions corresponding to those of the transmitting section supporting portions 86a, 86b, and 86c of the adjacent X-ray transmitting section 25, respectively. The absorbing section supporting portions 87a, 87b, and 87c may be provided in the same direction as the transmitting section supporting portions 86a, 86b, and 86c, respectively. The shapes of the absorbing section supporting portions 87a, 87b, and 87c correspond to those of the transmitting section supporting portions 86a, 86b, and 86c, respectively. Like a second grid 90 shown in FIG. 15, bent portions 93 of X-ray absorbing sections 91 and bent portions 94 of X-ray transmitting sections 92 may be provided as the supporting portions. The bent portions 93 and the bent portions 94 are bent (for example, stepwise) in the X direction.

In the above embodiments, the subject H is placed between the X-ray source and the first grid. It is also possible to generate a phase contrast image when the subject H is placed between the first and second grids. The second grid is scanned using the scan mechanism. Alternatively, the first grid may be scanned. In the above embodiments, the X-ray imaging system provided with the source grid is described. The present invention is also applicable to an X-ray imaging system with no source grid. The above embodiments may be combined with each other within a scope not contradicting each other.

In the above embodiments, the first grid is configured to linearly project the X-rays passed through its X-ray transmitting sections. Alternatively, the first grid may diffract the X-rays to cause the so-called Talbot effect (see WO 2004/058070, for example). In this case, a distance between the first and second grids needs to be set to a Talbot length. The first grid may be a phase grid with a relatively low aspect ratio instead of the absorption grid.

In the above embodiments, after the intensity of the fringe image is modulated by the second grid, the fringe image is detected using the fringe scanning method to generate a phase contrast image. Alternatively, there is an X-ray imaging system for generating a phase contrast image by a single image capture. For example, in an X-ray imaging system disclosed in U.S. Patent Application Publication No. 2011/0158493 (corresponding to WO 2010/050483), an X-ray image detector detects moiré fringes generated by the first and second grids. Intensity distribution of the moiré fringes is subjected to Fourier transform to obtain a spatial frequency spectrum. A spectrum corresponding to a carrier frequency is separated from the spatial frequency spectrum, and inverse Fourier transform is performed. Thereby, a differential phase image is obtained. The grid of the present invention may be used as at least one of first and second grids of this X-ray imaging system.

The X-ray imaging system which generates a phase contrast image by a single image capture may use a direct conversion type X-ray image detector as an intensity modulator instead of a second grid. The direct conversion type X-ray image detector is provided with a conversion layer for converting the X-rays into electric charge and a charge collection electrode for collecting the electric charge generated by the conversion layer. In the X-ray imaging system, for example, the charge collection electrode in each pixel is composed of linear electrode groups arranged to have mutually different phases. Each linear electrode group is composed of linear electrodes arranged at the period substantially coinciding with the periodic pattern of the fringe image, formed using the first grid, and electrically connected to each other. Each linear electrode group is controlled individually to collect the electric charge. Thereby, two or more fringe images are obtained by the single image capture. The phase contrast image is generated based on the fringe images obtained (see configuration disclosed in U.S. Pat. No. 7,746,981 corresponding to Japanese Patent Laid-Open Publication No. 2009-133823). The grid of the present invention may be used as the first grid of this X-ray imaging system.

There is another type of X-ray imaging system capable of generating a phase contrast image by a single image capture. In this X-ray imaging system, the first and second grids are arranged such that the extending direction of the X-ray absorbing sections and the extending direction of the X-ray transmitting sections are tilted by a predetermined angle relative to each other. The moiré period in the extending direction caused by the tilt is divided into segments and an image is captured. Thereby, fringe images, generated with the first and second grids in different relative positions, are obtained. A phase contrast image can be generated from the fringe images. The grid of the present invention can be used as at least one of the first and second grids of this X-ray imaging system.

There is another type of X-ray imaging system which uses an optical read-out type X-ray image detector as an intensity modulator to eliminate the use of the second grid. In this system, a first electrode layer, a photoconductive layer, a charge accumulation layer, and a second electrode layer are layered in this order. The first electrode layer transmits a periodic pattern image formed by a first grid. The photoconductive layer detects the periodic pattern image, transmitted through the first electrode layer, to generate electric charge. The charge accumulation layer accumulates the electric charge. The second electrode layer is provided with a plurality of linear electrodes that transmit read-out light. The linear electrodes correspond to respective pixels. An image signal is read out on a pixel-by-pixel basis by scanning using the read-out light. The charge accumulation layer is formed into a grid-like shape with a pitch smaller than an arrangement pitch of the linear electrodes. Thereby, the charge accumulation layer functions as the second grid. The grid of the present invention can be used as the first grid of this X-ray imaging system.

The above embodiments are applicable to radiation imaging systems for use in medical diagnosing, industrial applications, and non-destructive examinations, for example. The present invention is also applicable to an anti-scatter grid for removing scattered radiation during the X-ray imaging. In the present invention, it is also possible to use radiation other than X-rays, for example, gamma rays.

Various changes and modifications are possible in the present invention and may be understood to be within the present invention.

What is claimed is:

1. A grid for use in radiation imaging comprising:
a plurality of radiation absorbing sections extending in an extending direction;
a plurality of radiation transmitting sections extending in the extending direction, the radiation absorbing sections and the radiation transmitting sections being arranged alternately in an arranging direction orthogonal to the extending direction; and
a plurality of supporting portions protruding in the arranging direction from at least one of sides of the radiation transmitting sections.

2. The grid of claim 1, wherein the supporting portions do not contact the adjacent radiation transmitting section.

3. The grid of claim 2, wherein the supporting portions are provided on both sides of the radiation transmitting section alternately in the extending direction.

4. The grid of claim 2, wherein the supporting portions are protruded in opposite directions from the both sides at a same position of the radiation transmitting section.

5. The grid of claim 2, wherein the supporting portions protruding from the adjacent radiation transmitting sections in the arranging direction face each other.

6. The grid of claim 1, wherein the supporting portion includes a bent portion in which the radiation transmitting section is bent stepwise.

7. The grid of claim 1, wherein an arrangement pitch of the supporting portions in the extending direction is greater than or equal to 5 times a width of the radiation absorbing section in the arranging direction.

8. The grid of claim 7, wherein the arrangement pitch of the supporting portions in the extending direction is less than or equal to a pixel size of a radiation image detector for detecting radiation passed through the radiation transmitting sections.

9. The grid of claim 1, further including an absorbing section supporting portion protruded from at least one of sides of the radiation absorbing section.

10. A radiation imaging system comprising:
a first grid having a plurality of radiation absorbing sections and a plurality of radiation transmitting sections, the radiation absorbing sections and radiation transmitting sections extending in an extending direction and being arranged alternately in an arranging direction orthogonal to the extending direction, the first grid passing radiation emitted from a radiation source to form a first periodic pattern image, the first grid having a plurality of supporting portions protruding in the arranging direction from at least one of sides of the radiation transmitting sections; and
an intensity modulator for providing intensity modulation to the first periodic pattern image in at least one of relative positions out of phase with the first periodic pattern;
a radiation image detector for detecting a second periodic pattern image generated in the relative position by the intensity modulator; and
a processing section for generating an image of phase information based on at least one of the second periodic pattern images detected by the radiation image detector.

11. The radiation imaging system of claim 10, wherein the intensity modulator is composed of a second grid and a scanning section, and the second grid has a plurality of radiation transmitting sections, a plurality of radiation absorbing sections, and a plurality of supporting portions, and the radiation transmitting sections and the radiation absorbing sections extend in an extending direction and are arranged alternately in an arranging direction orthogonal to the extending direction, and the radiation transmitting sections pass the first periodic pattern, and the radiation absorbing sections absorb the first periodic pattern, and the supporting portions protrude in the arranging direction from at least one of sides of the radiation transmitting sections, and the scanning section moves one of the first and second grids to positions at a pitch in a periodic direction of grid structures of the first and second grids, and the positions correspond to the relative positions.

12. The radiation imaging system of claim 10, further including a third grid composed of a plurality of radiation absorbing sections, a plurality of radiation transmitting sections, and a plurality of supporting portions, the radiation absorbing sections and radiation transmitting sections extending in an extending direction and being arranged alternately in an arranging direction orthogonal to the extending direction, the supporting portions protruding in the arranging direction from at least one of sides of the radiation transmitting sections, the third grid being placed between the radiation source and the first grid, the third grid partly shielding the radiation from the radiation source to form a plurality of linear light sources.

13. A grid producing method comprising the steps of:
forming a plurality of grooves, a plurality of radiation transmitting sections, and a plurality of supporting portions on a radiation transmissive substrate, the grooves extending in an extending direction and being arranged in an arranging direction orthogonal to the extending direction, the grooves being formed between the radiation transmitting sections, the supporting portions protruding in the arranging direction from at least one of sides of the radiation transmitting sections; and
forming a plurality of radiation absorbing sections by filling the grooves with a radiation absorbing material.

14. The grid producing method of claim 13, wherein the supporting portions do not contact the adjacent radiation transmitting section.
